(19) United States
(12) Patent Application Publication
(10) Pub. No.: US 2026/0335791 A1
(43) Pub. Date: Oct. 29, 2026

(54) WATER OUTLET DEVICE WITH FILTER CARTRIDGE CONVENIENT TO REPLACE

(71) Applicant: Zhangzhou Taiwanese Investment Zone Jingxin Sanitary Ware Co., Ltd., Zhangzhou (CN)

(72) Inventors: Zemin YU, Zhangzhou (CN); Jiacong LIAN, Zhangzhou (CN)

(73) Assignee: Zhangzhou Taiwanese Investment Zone Jingxin Sanitary Ware Co., Ltd., Zhangzhou (CN)

(21) Appl. No.: 19/236,728

(22) Filed: Jun. 12, 2025

(30) Foreign Application Priority Data
Apr. 23, 2025 (CN) 2025207828308

(51) Int. Cl. B01D 27/00; E03C 1/04

(52) U.S. Cl. CPC B01D 27/00; E03C 1/04; E03C 2201/40

(57) ABSTRACT

The present invention provides a water outlet device with a filter cartridge convenient to replace, including a water outlet main body, a water outlet surface cover, and a quick release assembly. The water outlet main body is internally provided with a mounting cavity communicated with a water inlet channel, and the mounting cavity is provided with an opening for mounting the filter cartridge. The quick release assembly is mounted at the opening of the mounting cavity and includes a locking member, an unlocking member, and an auxiliary convex block. The locking member is mounted close to a circumference of the opening, to limit and maintain a state that the water outlet surface cover blocks the opening.

### CROSS-REFERENCE TO RELATED APPLICATIONS

The application claims priority to Chinese patent application No. 2025207828308, filed on Apr. 23, 2025, the entire contents of which are incorporated herein by reference.

### TECHNICAL FIELD

The present invention relates to the technical field of kitchens and bathrooms, and in particular, to a water outlet device with a filter cartridge convenient to replace.

### BACKGROUND

In pursuit of better water quality, many water outlet devices have a filtering function and a relatively simple filter cartridge detachment, mounting, and replacement structure. However, for some water outlet products that are fixedly mounted relatively, such as a top shower head, the mounting position of the top shower head is generally high, which is inconvenient for the user to detach, mount, and replace the filter cartridge, causing that many top shower heads do not have a filtering function. Therefore, the present invention provides a structure with a filter cartridge convenient to replace. At the same time, the structure also has the function of preventing accidental touch, which can avoid the situation that accidental touch unlocking causes parts to fall and be damaged.

### SUMMARY

To solve the above technical problems, the present invention provides a water outlet device structure with a filter cartridge convenient to replace.

A water outlet device with a filter cartridge convenient to replace, including a water outlet main body, a water outlet surface cover, and a quick release assembly, where

the water outlet main body is internally provided with a mounting cavity communicated with a water inlet channel, and the mounting cavity is provided with an opening for mounting the filter cartridge.

The quick release assembly is mounted at the opening of the mounting cavity and includes a locking member, an unlocking member, and an auxiliary convex block; the locking member is mounted close to a circumference of the opening, to limit and maintain a state that the water outlet surface cover blocks the opening; the unlocking member is rotatably mounted in the water outlet main body and is linked with the locking member, and the unlocking member is provided with a toggling switch extending to a periphery of the water outlet main body; and the auxiliary convex block is disposed on the periphery of the water outlet main body and is opposite to the toggling switch. During use, by tightly pinching the toggling switch and the auxiliary convex block, the toggling switch is driven to move toward the auxiliary convex block and drive the unlocking member to rotate, the unlocking member drives the locking member through rotation to switch to an unlocked state, and the water outlet surface cover and the opening are released from a relatively fixed state. Therefore, a user can replace the filter cartridge in the mounting cavity and only needs to use the water outlet surface cover to block the mounting cavity again subsequently, and the locking member locks the water outlet surface cover again.

In the present invention, the quick release assembly is disposed, so that the water outlet surface cover can be quickly unlocked, to facilitate detaching the water outlet surface cover, which helps replace and mount some filter cartridges of water outlet devices that are mounted highly and are not easy to detach. In addition, the quick release assembly adopts an unlocking structure of tightly pinching the toggling switch and the auxiliary convex block, so that an accidental touch can be avoided.

Preferably, a circumference of the water outlet surface cover is provided with a limiting groove, a portion, facing an axial center of the mounting cavity, of the locking member forms a lock tongue, and the locking member is snapped into the limiting groove through the lock tongue to limit the state that the water outlet surface cover blocks the opening.

Preferably, the limiting groove is an annular groove, so that the limiting groove can be matched with the locking member at various angles, thereby improving convenience during assembling.

Preferably, one end, facing the mounting cavity, of the water outlet surface cover is provided with a docking head, the limiting groove is formed on a circumference of the docking head, the docking head is inserted into the opening when the water outlet surface cover blocks the opening, the circumference of the opening is provided with a guiding opening, and the lock tongue enters the mounting cavity through the guiding opening and is snapped into the limiting groove.

Preferably, the locking member is movably mounted in a radial direction of the mounting cavity, a first spring is disposed between the locking member and the water outlet main body, the first spring pushes the locking member to move toward a center of the mounting cavity, and the unlocking member drives the locking member to move away from the mounting cavity and to further compress the first spring. At this time, the first spring provides a reset force for the locking member.

Preferably, the locking member is provided with a pushing rod perpendicular to a moving direction, the unlocking member is located at an unlocking portion that is between the pushing rod and the mounting cavity, and during unlocking, the unlocking portion pushes the pushing rod through movement to move away from the mounting cavity and drives the locking member to switch to the unlocked state. The unlocking structure is simple and is easy to form.

Preferably, to reduce structural complexity of the unlocking member, the unlocking portion is a groove accommodating the pushing rod, a side wall of the groove is an unlocking surface, and the unlocking surface is an inclined surface or a curved surface, gradually enters between the pushing rod and the mounting cavity during the unlocking, and pushes the pushing rod to move.

Preferably, three locking members are disposed and are uniformly distributed on a periphery of the mounting cavity, the unlocking member is annular and is sleeved on the periphery of the mounting cavity, and three unlocking portions are also disposed and are distributed on the unlocking member corresponding to the three locking members; and a second spring is disposed between the unlocking member and the water outlet main body, and the second spring pushes the toggling switch to move away from the auxiliary convex block, to maintain a state that the unlocking portion releases the pushing rod, thereby preventing the unlocking member from maintaining the locking member in the unlocked state all the time.

Preferably, to quickly detach the water outlet surface cover, a push-out assembly is further disposed between the water outlet main body and the water outlet surface cover, the push-out assembly includes a push-out member and a third spring, one end of the push-out member is telescopically mounted in a guiding hole of the water outlet main body, an end portion passes through the guiding hole and is provided with an undercut, the other end of the push-out member is provided with a push-out head portion, the third spring is compressively disposed between the push-out member and the water outlet main body and pushes the push-out head portion to abut against the water outlet surface cover, and when the locking member is in the unlocked state, the push-out assembly automatically pushes out the water outlet surface cover.

Preferably, to add a function of the water outlet device, a water outlet state switching function is further provided. The water outlet surface cover is provided with a communicated water passing channel, a switching cavity, and at least two water outlet channels, a rotary switching valve core is disposed in the switching cavity, a toggle is disposed on a water outlet surface plate of the water outlet surface cover, is rotatably mounted in the water outlet surface cover, and drives the rotary switching valve core to switch any water outlet channel to be communicated with the water passing channel, and the water outlet channels form different water outlet nozzles at a water outlet end of the water outlet surface plate.

It can be known from the above description of the present invention that the present invention has the following beneficial effects:
1. In the present invention, the quick release assembly is disposed, so that the sealing cover can be quickly unlocked, to facilitate detaching the sealing cover, which helps replace and mount some filter cartridges of water outlet devices that are mounted highly and are not easy to detach. In addition, the quick release assembly adopts an unlocking structure of tightly pinching the toggling switch and the auxiliary convex block, so that an accidental touch can be avoided, and a one-handed operation can further be implemented. In this way, one hand is used for unlocking, and the other hand holds a filter, to prevent a sudden fall.
2. The pushing rod and the unlocking portion that is of a groove shape are adopted, which has advantages of simple structure, easy formation, easy assembling, and easy unlocking.
3. The unlocking member adopts a rotatable mounting manner of sleeving on the periphery of the mounting cavity, so that a mounting structure is simple and firm and reliable.
4. The push-out assembly is further disposed between the water outlet main body and the water outlet surface cover, so that the water outlet surface cover can be quickly detached.

### BRIEF DESCRIPTION OF THE DRAWINGS

The accompanying drawings described herein are intended for further understanding of the present invention and constitute a part of the present invention. Schematic embodiments of the present invention and descriptions thereof are intended to explain the present invention, and do not constitute any inappropriate limitation on the present invention.

In the accompanying drawings:

FIG. 1 is an axial side view of a water outlet device with a filter cartridge convenient to replace;

FIG. 2 is an exploded view 1 of a water outlet device with a filter cartridge convenient to replace;

FIG. 3 is an exploded view 2 of a water outlet device with a filter cartridge convenient to replace;

FIG. 4 is an exploded view 3 of a water outlet device with a filter cartridge convenient to replace;

FIG. 5 is an exploded view 4 of a water outlet device with a filter cartridge convenient to replace;

FIG. 6 is a front view of a water outlet device with a filter cartridge convenient to replace;

FIG. 7 is a sectional view 1 of a water outlet device with a filter cartridge convenient to replace; (related to a position A-A of FIG. 6)

FIG. 8 is a sectional view 2 of a water outlet device with a filter cartridge convenient to replace; (related to a position B-B of FIG. 6) and

FIG. 9 is a sectional view 3 of a water outlet device with a filter cartridge convenient to replace. (related to a position C-C of FIG. 8)

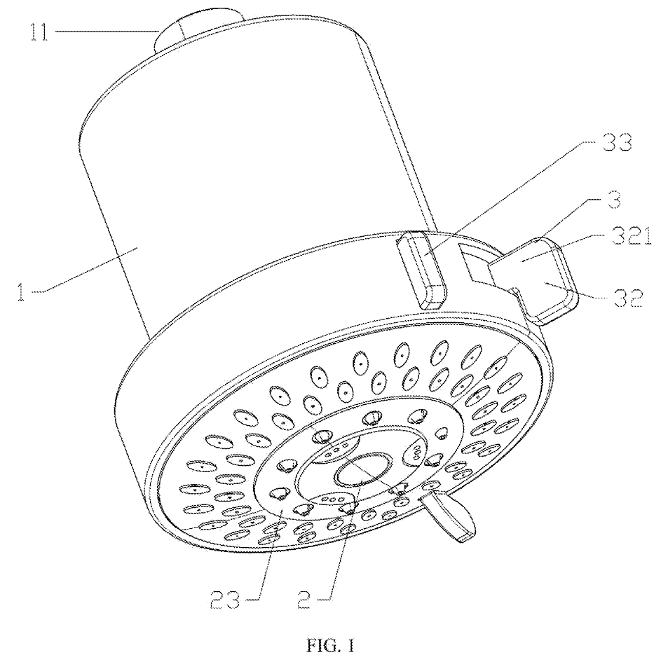

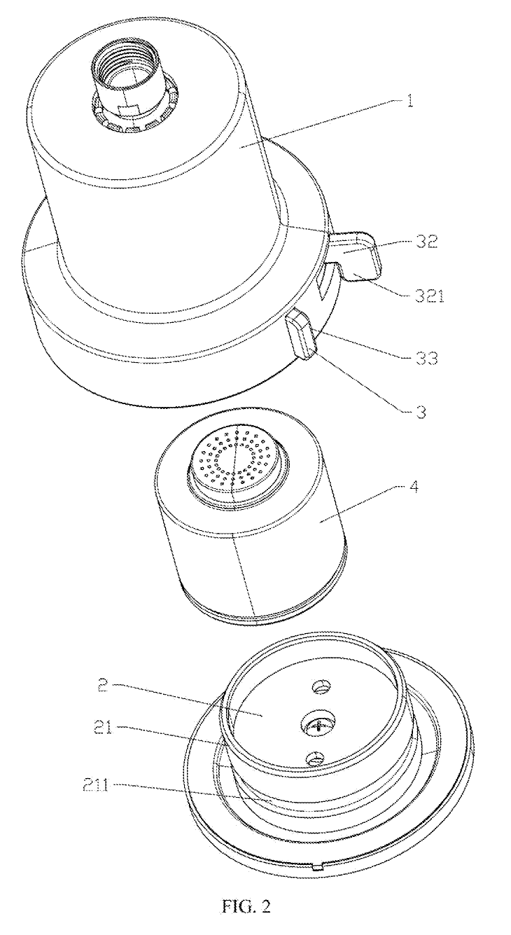

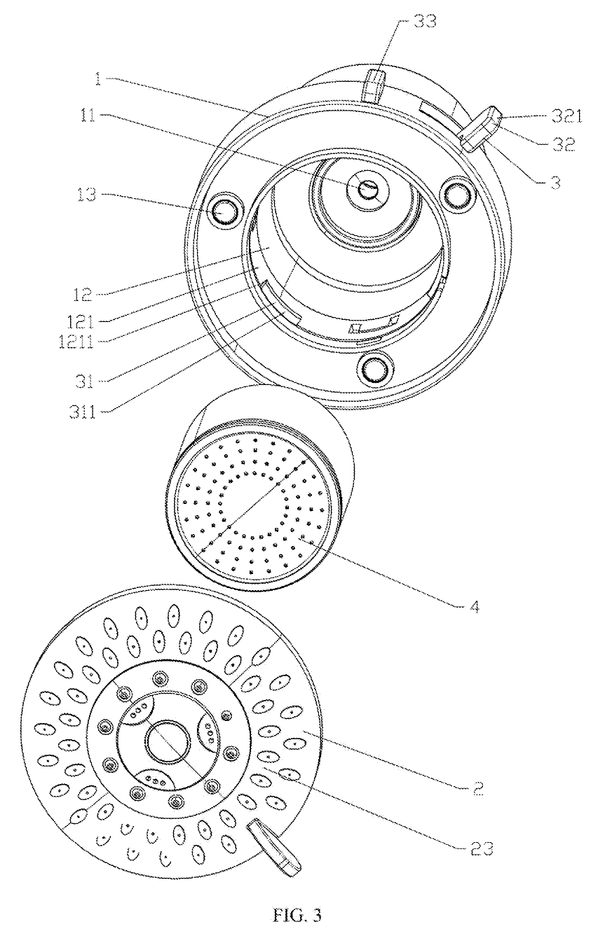

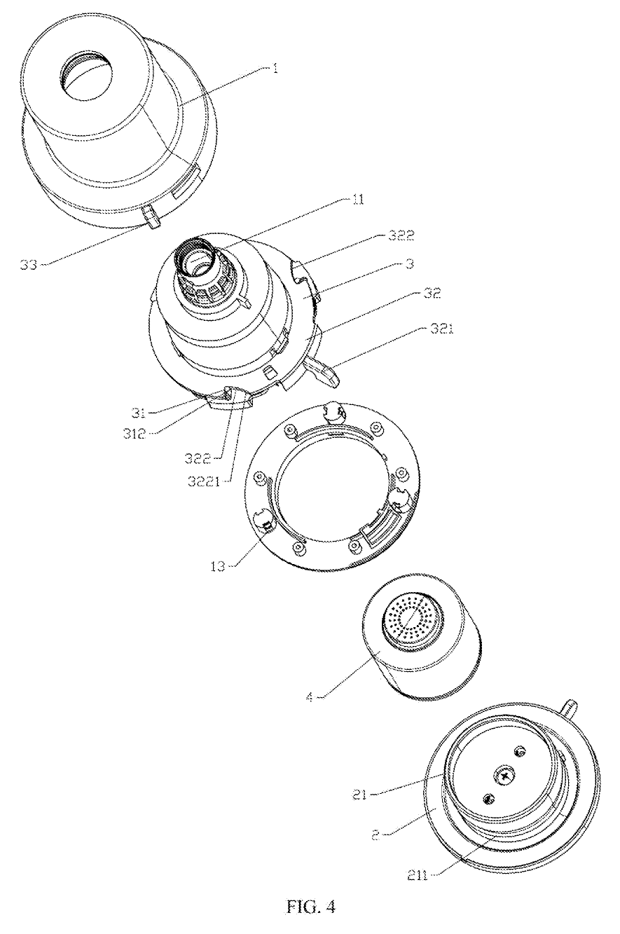

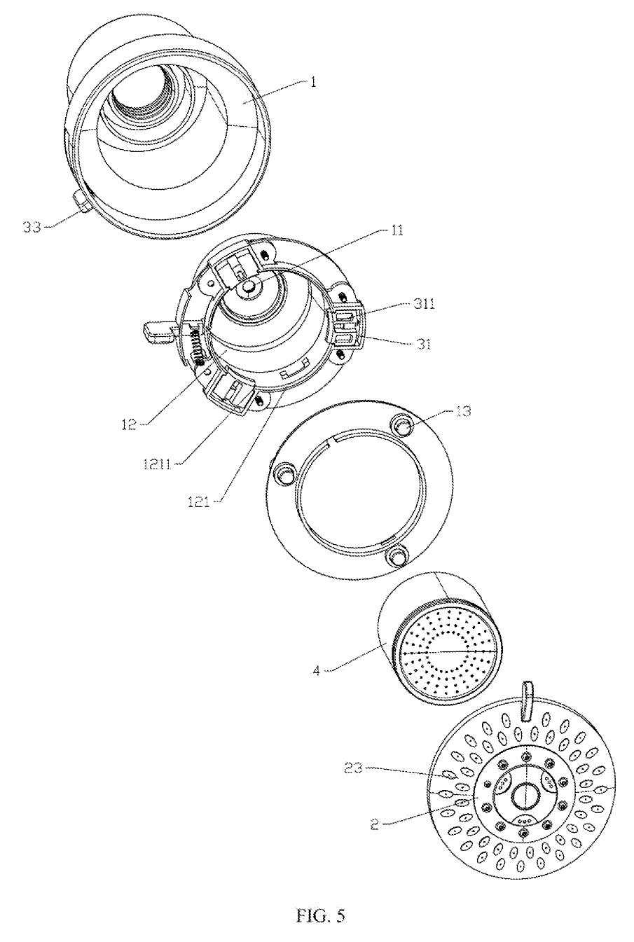

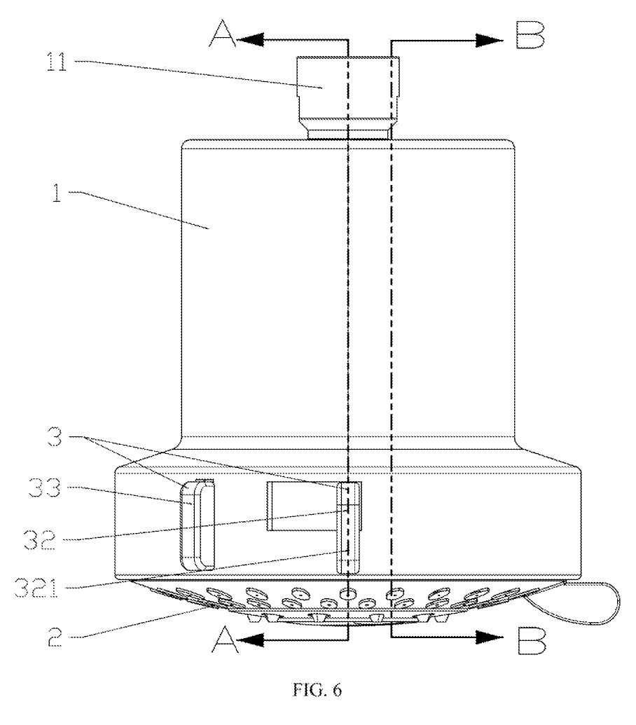

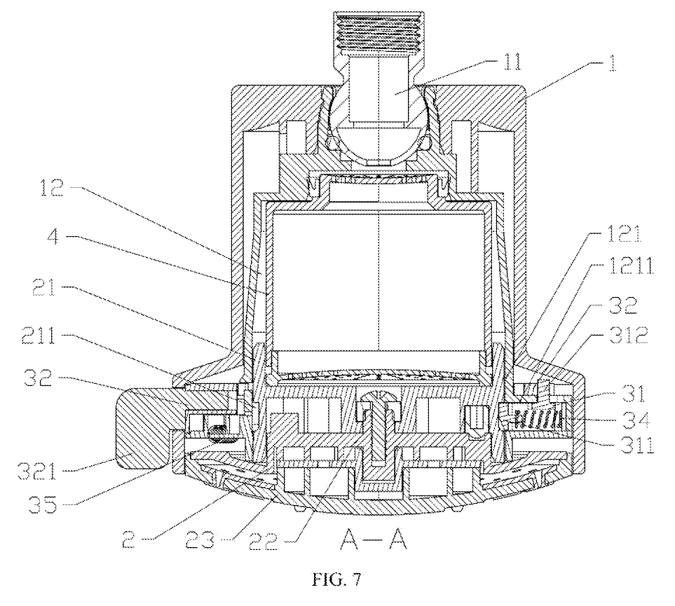

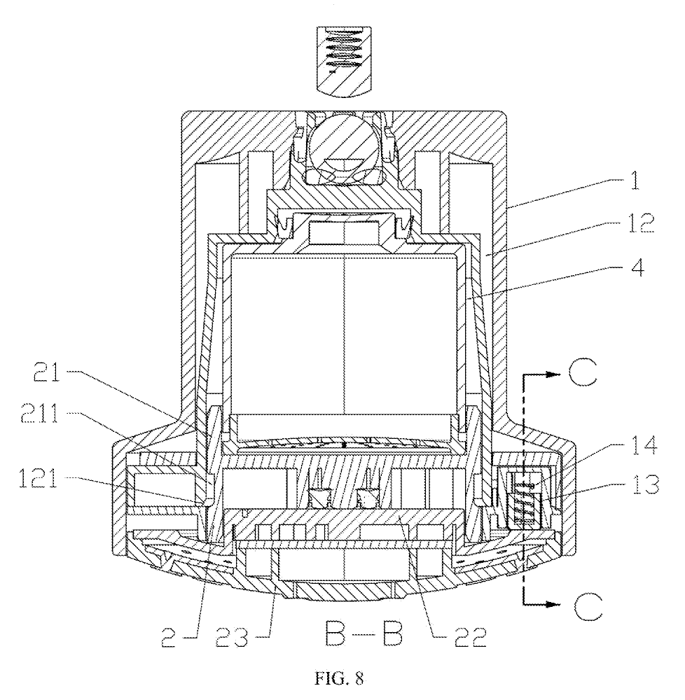

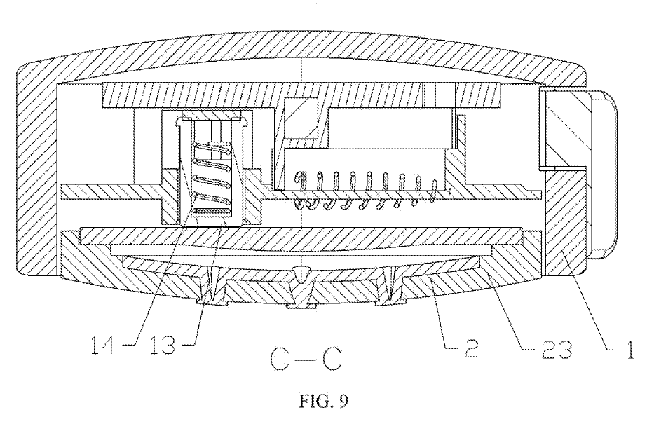

Reference numerals in FIGS. 1 to 9 respectively are: 1. water outlet main body; 11. water inlet channel; 12. mounting cavity; 121. opening; 1211. guiding opening; 13. push-out member; 14. third spring; 2. water outlet surface cover; 21. docking head; 211. limiting groove; 22. rotary switching valve core; 23. water outlet surface plate; 3. quick release assembly; 31. locking member; 311. lock tongue; 312. pushing rod; 32. unlocking member; 321. toggling switch; 322. unlocking portion; 3221. unlocking surface; 33. auxiliary convex block; 34. first spring; 35. second spring; 4. filter cartridge.

### DETAILED DESCRIPTION OF THE EMBODIMENTS

To make the technical problems to be solved, technical solutions, and beneficial effects in the present invention clearer and more comprehensible, the following further describes the present invention in detail with reference to the accompanying drawings and embodiments. It should be understood that, the specific embodiments described herein are merely used to explain the present invention but not to limit the present invention.

Referring to FIGS. 1 to 9, a water outlet device with a filter cartridge 4 convenient to replace includes a water outlet main body 1, a water outlet surface cover 2, and a quick release assembly 3, where

the water outlet main body 1 is internally provided with a mounting cavity 12 communicated with a water inlet channel 11, and the mounting cavity 12 is provided with an opening 121 for mounting the filter cartridge 4.

The quick release assembly 3 is mounted at the opening 121 of the mounting cavity 12 and includes a locking member 31, an unlocking member 32, and an auxiliary convex block 33. The locking member 31 is mounted close to a circumference of the opening 121, to limit and maintain a state that the water outlet surface cover 2 blocks the opening 121. The unlocking member 32 is rotatably mounted in the water outlet main body 1 and is linked with the locking member 31, and the unlocking member 32 is provided with a toggling switch 321 extending to a periphery of the water outlet main body 1. The auxiliary convex block 33 is disposed on the periphery of the water outlet main body 1 and is opposite to the toggling switch 321. During use, by tightly pinching the toggling switch 321 and the auxiliary convex block 33, the toggling switch 321 is driven to move toward the auxiliary convex block 33 and drive the unlocking member 32 to rotate, the unlocking member 32 drives the locking member 31 through rotation to switch to an unlocked state, and the water outlet surface cover 2 and the opening 121 are released from a relatively fixed state. Therefore, a user can replace the filter cartridge 4 in the mounting cavity 12 and only needs to use the water outlet surface cover 2 to block the mounting cavity 12 again subsequently, and the locking member 31 locks the water outlet surface cover 2 again.

For a locking structure of the locking member 31, in an embodiment, a circumference of the water outlet surface cover 2 is provided with a limiting groove 211. A portion, facing an axial center of the mounting cavity 12, of the locking member 31 forms a lock tongue 311, and the locking member 31 is snapped into the limiting groove 211 through the lock tongue 311 to limit the state that the water outlet surface cover 2 blocks the opening 121. Preferably, the limiting groove 211 is an annular groove, so that the limiting groove can be matched with the locking member 31 at various angles, thereby improving convenience during assembling.

Further, in another embodiment, one end, facing the mounting cavity 12, of the water outlet surface cover 2 is provided with a docking head 21, and the limiting groove 211 is formed on a circumference of the docking head 21. The docking head 21 is inserted into the opening 121 when the water outlet surface cover 2 blocks the opening 121, and the circumference of the opening 121 is provided with a guiding opening 1211. The lock tongue 311 enters the mounting cavity 12 through the guiding opening 1211 and is snapped into the limiting groove 211.

Based on the above embodiments, for a specific structure of the locking member 31, in an embodiment, the locking member 31 is movably mounted in a radial direction of the mounting cavity 12, and a first spring 34 is disposed between the locking member 31 and the water outlet main body 1. The first spring 34 pushes the locking member 31 to move toward a center of the mounting cavity 12, and the unlocking member 32 drives the locking member 31 to move away from the mounting cavity and to further compress the first spring 34. At this time, the first spring 34 provides a reset force for the locking member 31. In addition, the locking member 31 is provided with a pushing rod 312 perpendicular to a moving direction, and the unlocking member 32 is located at an unlocking portion 322 that is between the pushing rod 312 and the mounting cavity 12. During unlocking, the unlocking portion 322 pushes the pushing rod 312 through movement to move away from the mounting cavity 12 and drives the locking member 31 to switch to the unlocked state. An unlocking structure is simple and is easy to form.

Further, in another embodiment, to reduce structural complexity of the unlocking member 32, the unlocking portion 322 is a groove accommodating the pushing rod 312, and a side wall of the groove is an unlocking surface 3221. The unlocking surface 3221 is an inclined surface or a curved surface, gradually enters between the pushing rod 312 and the mounting cavity 12 during the unlocking, and pushes the pushing rod 312 to move.

Based on the above embodiments, three locking members 31 are disposed and are uniformly distributed on a periphery of the mounting cavity 12. The unlocking member 32 is annular and is sleeved on the periphery of the mounting cavity 12. Three unlocking portions 322 are also disposed and are distributed on the unlocking member 32 corresponding to the three locking members 31. A second spring 35 is disposed between the unlocking member 32 and the water outlet main body 1, and the second spring 35 pushes the toggling switch 321 to move away from the auxiliary convex block, to maintain a state that the unlocking portion 322 releases the pushing rod 312, thereby preventing the unlocking member 32 from maintaining the locking member 31 in the unlocked state all the time.

In an embodiment, to quickly detach the water outlet surface cover 2, a push-out assembly is further disposed between the water outlet main body 1 and the water outlet surface cover 2. The push-out assembly includes a push-out member 13 and a third spring 14. One end of the push-out member 13 is telescopically mounted in a guiding hole of the water outlet main body 1, and an end portion passes through the guiding hole and is provided with an undercut. The other end of the push-out member 13 is provided with a push-out head portion, and the third spring 14 is compressively disposed between the push-out member 13 and the water outlet main body 1 and pushes the push-out head portion to abut against the water outlet surface cover 2. When the locking member 31 is in the unlocked state, the push-out assembly automatically pushes out the water outlet surface cover 2.

In an embodiment, to add a function of the water outlet device, a water outlet state switching function is further provided. The water outlet surface cover 2 is provided with a communicated water passing channel, a switching cavity, and at least two water outlet channels. A rotary switching valve core 22 is disposed in the switching cavity. A toggle is disposed on a water outlet surface plate 23 of the water outlet surface cover 2, is rotatably mounted in the water outlet surface cover 2, and drives the rotary switching valve core 22 to switch any water outlet channel to be communicated with the water passing channel, and the water outlet channels form different water outlet nozzles at a water outlet end of the water outlet surface plate 23.

The water outlet device provided by the present invention is used, for example, a top shower head. When the filter cartridge 4 in the water outlet device is replaced, the toggling switch 321 and the auxiliary convex block 33 are pinched tightly, to drive the toggling switch 321 to move toward the auxiliary convex block 33 and drive the unlocking member 32 to rotate. The unlocking member 32 drives the locking member 31 through rotation to switch to an unlocked state, and the water outlet surface cover 2 and the opening 121 are released from a relatively fixed state. Therefore, the user can replace the filter cartridge 4 in the mounting cavity 12 and only needs to use the water outlet surface cover 2 to block the mounting cavity 12 again subsequently, and the locking member 31 locks the water outlet surface cover 2 again.

In the present invention, the quick release assembly 3 is disposed, so that the sealing cover can be quickly unlocked, to facilitate detaching the sealing cover, which helps replace and mount some filter cartridges 4 of water outlet devices that are mounted highly and are not easy to detach. In addition, the quick release assembly 3 adopts an unlocking structure of tightly pinching the toggling switch 321 and the auxiliary convex block 33, so that an accidental touch can be avoided, and a one-handed operation can further be implemented. In this way, one hand is used for unlocking, and the other hand holds a filter, to prevent a sudden fall.

Although the above embodiments have been shown and described, it can be understood that the above embodiments are examples and shall not be construed as a limitation on the present invention. Changes, modifications, substitutions, and variants made by those of ordinary skill in the art on the above embodiments shall fall within the protection scope of the present invention.

What is claimed is:

1. A water outlet device with a filter cartridge convenient to replace, comprising a water outlet main body, a water outlet surface cover, and a quick release assembly, wherein
the water outlet main body is internally provided with a mounting cavity communicated with a water inlet channel, and the mounting cavity is provided with an opening for mounting the filter cartridge; and
the quick release assembly is mounted at the opening of the mounting cavity and comprises a locking member, an unlocking member, and an auxiliary convex block; the locking member is mounted close to a circumference of the opening, to limit and maintain a state that the water outlet surface cover blocks the opening; the unlocking member is rotatably mounted in the water outlet main body and is linked with the locking member, and the unlocking member is provided with a toggling switch extending to a periphery of the water outlet main body; the auxiliary convex block is disposed on the periphery of the water outlet main body and is opposite to the toggling switch; and by tightly pinching the toggling switch and the auxiliary convex block, the toggling switch is driven to move toward the auxiliary convex block and drive the unlocking member to rotate, the unlocking member drives the locking member through rotation to switch to an unlocked state, and the water outlet surface cover and the opening are released from a relatively fixed state.

2. The water outlet device with a filter cartridge convenient to replace according to claim 1, wherein a circumference of the water outlet surface cover is provided with a limiting groove, a portion, facing an axial center of the mounting cavity, of the locking member forms a lock tongue, and the locking member is snapped into the limiting groove through the lock tongue to limit the state that the water outlet surface cover blocks the opening.

3. The water outlet device with a filter cartridge convenient to replace according to claim 2, wherein the limiting groove is an annular groove.

4. The water outlet device with a filter cartridge convenient to replace according to claim 2, wherein one end, facing the mounting cavity, of the water outlet surface cover is provided with a docking head, the limiting groove is formed on a circumference of the docking head, the docking head is inserted into the opening when the water outlet surface cover blocks the opening, the circumference of the opening is provided with a guiding opening, and the lock tongue enters the mounting cavity through the guiding opening and is snapped into the limiting groove.

5. The water outlet device with a filter cartridge convenient to replace according to claim 1, wherein the locking member is movably mounted in a radial direction of the mounting cavity, a first spring is disposed between the locking member and the water outlet main body, the first spring pushes the locking member to move toward a center of the mounting cavity, and the unlocking member drives the locking member to move away from the mounting cavity and to further compress the first spring.

6. The water outlet device with a filter cartridge convenient to replace according to claim 5, wherein the locking member is provided with a pushing rod perpendicular to a moving direction, the unlocking member is located at an unlocking portion that is between the pushing rod and the mounting cavity, and during unlocking, the unlocking portion pushes the pushing rod through movement to move away from the mounting cavity and drives the locking member to switch to the unlocked state.

7. The water outlet device with a filter cartridge convenient to replace according to claim 6, wherein the unlocking portion is a groove accommodating the pushing rod, a side wall of the groove is an unlocking surface, and the unlocking surface is an inclined surface or a curved surface, gradually enters between the pushing rod and the mounting cavity during the unlocking, and pushes the pushing rod to move.

8. The water outlet device with a filter cartridge convenient to replace according to claim 6, wherein three locking members are disposed and are uniformly distributed on a periphery of the mounting cavity, the unlocking member is annular and is sleeved on the periphery of the mounting cavity, and three unlocking portions are also disposed and are distributed on the unlocking member corresponding to the three locking members; and a second spring is disposed between the unlocking member and the water outlet main body, and the second spring pushes the toggling switch to move away from the auxiliary convex block, to maintain a state that the unlocking portion releases the pushing rod.

9. The water outlet device with a filter cartridge convenient to replace according to claim 1, wherein a push-out assembly is further disposed between the water outlet main body and the water outlet surface cover, the push-out assembly comprises a push-out member and a third spring, one end of the push-out member is telescopically mounted in a guiding hole of the water outlet main body, an end portion passes through the guiding hole and is provided with an undercut, the other end of the push-out member is provided with a push-out head portion, and the third spring is compressively disposed between the push-out member and the water outlet main body and pushes the push-out head portion to abut against the water outlet surface cover.

10. The water outlet device with a filter cartridge convenient to replace according to claim 1, wherein the water outlet surface cover is provided with a communicated water passing channel, a switching cavity, and at least two water outlet channels, a rotary switching valve core is disposed in the switching cavity, a toggle is disposed on a water outlet surface plate of the water outlet surface cover, is rotatably mounted in the water outlet surface cover, and drives the rotary switching valve core to switch any water outlet channel to be communicated with the water passing channel, and the water outlet channels form different water outlet nozzles at a water outlet end of the water outlet surface plate.
